(19) United States
(12) Patent Application Publication
(10) Pub. No.: US 2007/0170621 A1
(43) Pub. Date: Jul. 26, 2007

(54) Cover and method for manufacturing the same

(75) Inventors: Jeng-Chi Peng, Tu-Cheng (TW); Wan-Te Huang, Tu-Cheng (TW); Zhi-Liang Mei, Shenzhen (CN); Kun-Peng Cheng, Shenzhen (CN); Qiang Liu, Shenzhen (CN); Zu-Lu Lin, Shenzhen (CN)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/520,134

(22) Filed: Sep. 13, 2006

(30) Foreign Application Priority Data
Jan. 21, 2006 (CN) 200610033197.4

(51) Int. Cl. B29C 45/00

(52) U.S. Cl. 264/328.1; 428/411.1

(57) ABSTRACT

The present invention discloses a cover including a base, a patterned layer, a protective layer and a bottom layer. The base has a first surface, and a second surface on the opposite side of the first surface. The patterned layer is formed on the first surface of the base. The protective layer and the bottom layer are integrally formed on the second surface of the base and on the patterned layer respectively by injection molding. The present invention also provides a method for manufacturing a cover. The present cover can tend give a various and vivid appearances whilst also having good performance.

### CROSS-REFERENCE TO RELATED APPLICATIONS

This application is related to a co-pending U.S. Patent Applications, entitled “COVER AND METHOD FOR MANUFACTURING THE SAME”, by Jeng-Chi Peng et al. with Attorney Docket No. 14963-56249. Such application has the same assignee as the present application and has been concurrently filed herewith. The disclosure of the above identified application is incorporated herein by reference.

### 1. TECHNICAL FIELD

The present invention relates generally to covers, and more particularly to a cover with multiple layers having an improved performance and appearance. The present invention also relates to a method for manufacturing the cover.

### 2. BACKGROUND

Covers are widely used for the purpose of protecting gadgets, such as notebook computers, personal digital assistants, mobile phones, car instruments, and so on. To make these gadgets more physical appealing, the covers are decorated to have good appearances. Covers having exhibiting different appearances are prepared by one of coating, double injection molding, and in-mold labeling methods.

Typically, a cover is manufactured by a method of coating a resin layer on a surface of a colored sheet or film. However, the resin layer of such cover is prone to be broken off from the colored sheet or film, thus the appearance of cover is influenced. The method of double injection molding is carried out by injecting two kinds of materials separately into a mold, thereby forming a cover having patterns thereon. However, the patterns of such cover are simple. The in-mold labeling method typically includes the following steps of: adhering a film having patterns on an inner wall of a mold, and a surface having patterns of the film being in contact with the inner wall of the mold; introducing a molten thermoplastic resin into the mold to form a resin layer on the film; cooling the resin layer to combine with the film to form a cover. However, the surface with patterns of such cover is exposed on the exterior, as a result, the patterns are prone to be scratched, thus appearance of cover is influenced in use. Furthermore, if the covers require vivid appearances by compounding multiple patterns and colors, the above methods for manufacturing the cover are hardly achieved.

Therefore, what is needed is to provide a cover that can tend give various and vivid appearances whilst also having good performance, and a method for manufacturing the same.

### SUMMARY

A cover according to a preferred embodiment includes a base, a patterned layer, a protective layer and a bottom layer. The base has a first surface, and a second surface on the opposite side of the first surface. The patterned layer is formed on the first surface of the base. The protective layer and the bottom layer are integrally formed on the second surface of the base and on the patterned layer respectively by injection molding.

A method for manufacturing a cover according to another preferred embodiment includes the following steps: providing a base, which has a first surface, and a second surface on the opposite side of the first surface; forming a patterned layer on the first surface of the base; forming a protective layer on the second surface of the base by injection molding; and forming a bottom layer on the patterned layer by injection molding.

Other advantages and novel features will become more apparent from the following detailed description of the preferred embodiments, when taken in conjunction with the accompanying drawings.

### BRIEF DESCRIPTION OF THE DRAWINGS

Many aspects of the present cover and a method for manufacturing the same can be better understood with reference to the following drawings. The components in the drawings are not necessarily drawn to scale, the emphasis instead being placed upon clearly illustrating the principles of the cover and a method for manufacturing the same. Moreover, in the drawings, like reference numerals designate corresponding parts throughout the several views.

FIG. 1 is a schematic, cross-sectional view of a cover according to a preferred embodiment;

FIG. 2 a flow chart of a method for manufacturing the cover of FIG. 1;

FIG. 3 is a schematic, cross-sectional view of a base of FIG. 1;

FIG. 4 is a schematic, cross-sectional view of the base and a patterned layer on the base of FIG. 1;

FIG. 5 is a schematic, cross-sectional view of the base having the patterned layer and a coating layer thereon of FIG. 1;

FIG. 6 is a schematic, cross-sectional view of the base having the patterned layer thereon after molding of FIG. 1;

FIG. 7 is a schematic, cross-sectional view of an apparatus in the period of forming a protective layer for manufacturing the cover of FIG. 1;

FIG. 8 is a schematic, cross-sectional view of an apparatus in the period of forming a bottom layer for manufacturing the cover of FIG. 1;

FIG. 9 is a schematic, cross-sectional view of an apparatus in the period of forming the bottom layer before forming the protective layer for manufacturing the cover of FIG. 1; and

FIG. 10 is a schematic, cross-sectional view of an apparatus in the period of forming the protective layer after forming the bottom layer for manufacturing the cover of FIG. 1.

### DETAILED DESCRIPTION OF THE PREFERRED EMBODIMENTS

Reference will now be made to the drawings to describe preferred embodiments of the present cover and method for manufacturing the same, in detail.

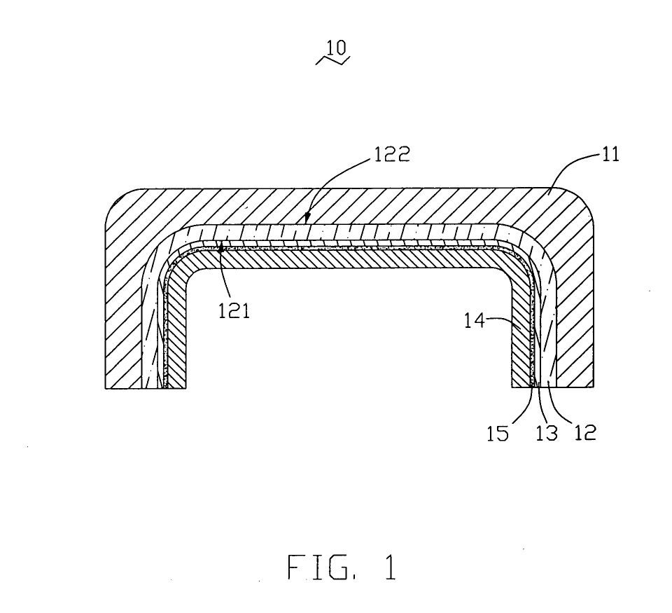

Referring to FIG. 1, a cover 10 according to a first preferred embodiment is shown. The cover 10 includes a protective layer 11, a base 12, a patterned layer 13, and a bottom layer 14. A first surface 121 and a second surface 122 are on opposite sides of the base 12. The patterned layer 13 is formed on the first surface 121 of the base 12. The protective layer 11 and the bottom layer 14 are integrally formed on the second surface 122 and the patterned layer 13 respectively by injection molding.

The base 12 is a sheet or a film. A material of the base 12 is selected from a group consisting of polycarbonate, acrylonitrile-butadiene-styrene terpolymer, polyvinyl chloride, polyamide, and polymethyl methacrylate.

The patterned layer 13 is used to provide patterns or colors of the cover. The patterned layer 13 is made up of printing ink layer, metal plated layer, or any combination thereof. Since the patterned layer 13 can be produced independently on the base 12, the patterned layer 13 may be prepared to have predetermined colors or patterns; thus, the cover 10 can exhibit complex and vivid appearances easily.

The protective layer 11 is to be exposed on the exterior, thus the protective layer 11 is configured to be translucent, semi-transparent, or transparent for the visualization of the patterned layer 13 on the base 12. A material of the protective layer 11 is selected from a group consisting of polycarbonate, acrylonitrile-butadiene-styrene terpolymer, and polymethyl methacrylate.

The bottom layer 14 mainly employs plastic. For example, the plastic is selected from a group consisting of polycarbonate, acrylonitrile-butadiene-styrene terpolymer, polyvinyl chloride, polyethylene, polystyrene, polyamide, and any combination thereof.

In use, the protective layer 11 and bottom layer 14 cooperatively protect the base 12 and the patterned layer 13. Therefore, the cover 10 has a relatively long operational life because the patterned layer 13 is prevented from being distorted or scratched.

Further, to prevent the patterned layer 13 from being distorted during the process of forming the protective layer 11 or bottom layer 14, the cover 10 includes a coating layer 15 between patterned layer 13 and bottom layer 14. A material of the coating layer 15 is selected from a group consisted of polyamide, polystyrene and polypropylene.

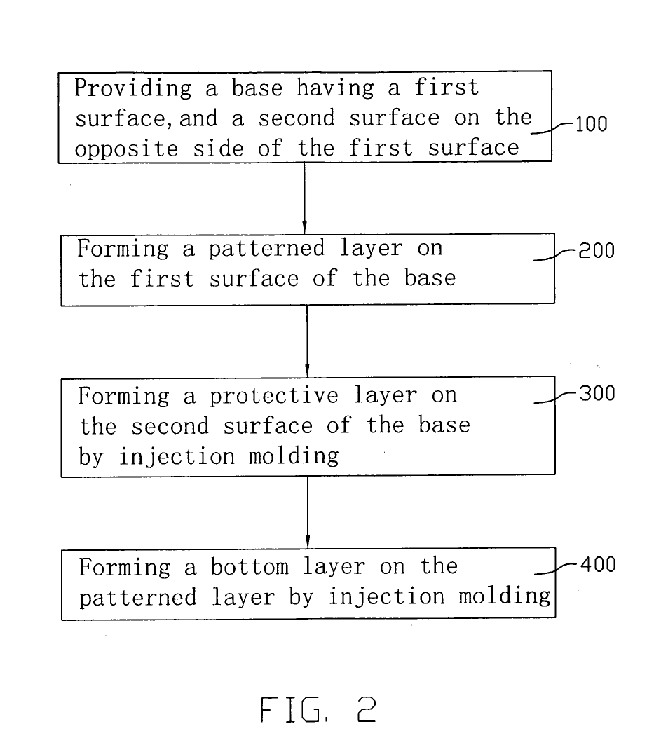

Referring to FIG. 2, a flow chart of a method for manufacturing the cover 10 is shown. The method includes following steps of:

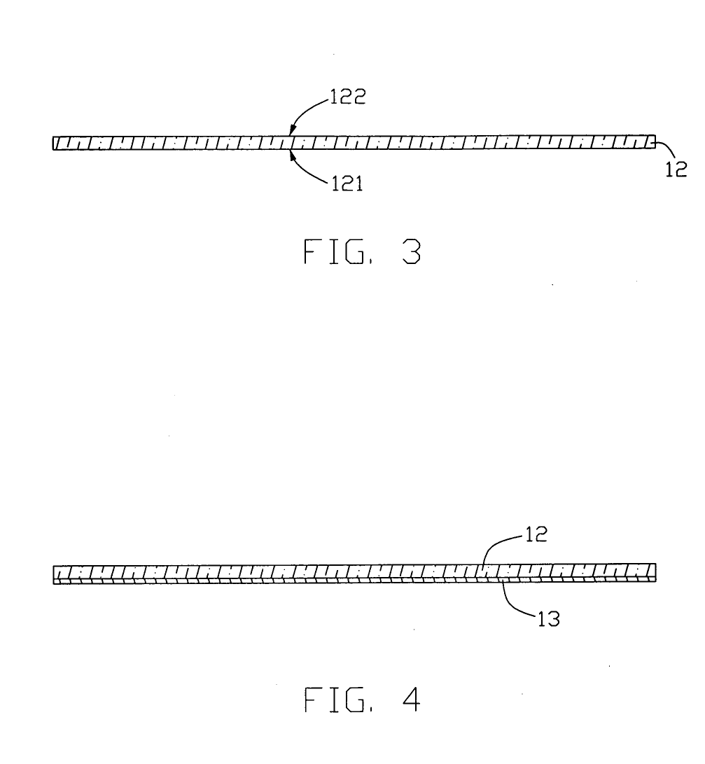

step 100: also referring to FIG. 3, providing the base 12 having the first surface 121, and the second surface 122 on opposite sides thereof;

step 200: also referring to FIG. 4, forming the patterned layer 13 on the first surface 121 of the base 12;

step 300: forming the protective layer 11 on the second surface 122 of the base 11 by injection molding; and

step 400: forming the bottom layer 14 on the patterned layer 13 by injection molding.

In step 100, the base 12 is a sheet or a film. A material of the base 12 is selected from a group consisting of polycarbonate, acrylonitrile-butadiene-styrene terpolymer, polyvinyl chloride, polyamide, and polymethyl methacrylate.

In step 200, forming the patterned layer 13 is performed by electroplating, evaporation, sputtering, or printing. Preferably, the patterned layer is prepared by printing, for example, screen printing.

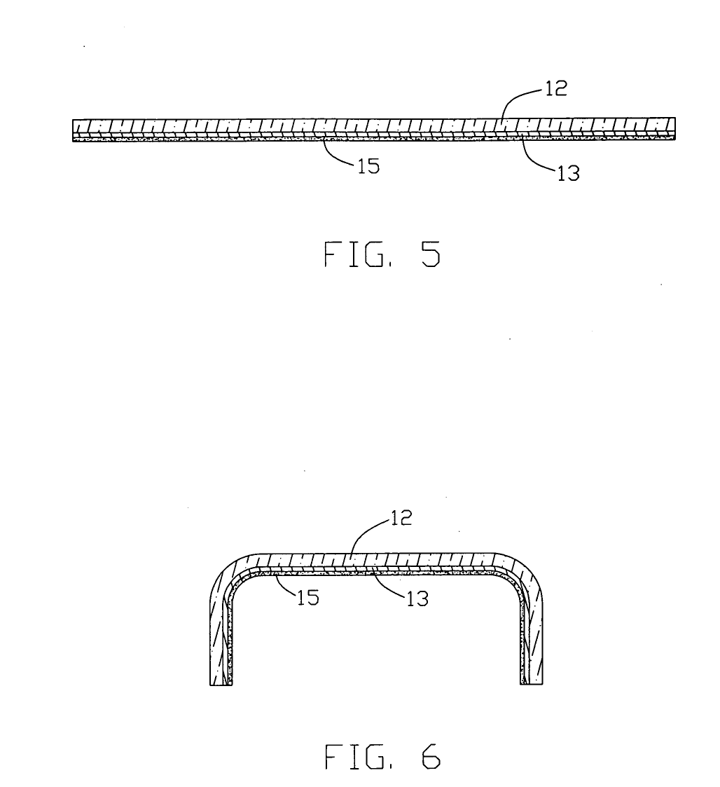

Further, referring to FIG. 5 after forming the patterned layer 13, a coating resin is applied on the patterned layer 13 after step 200, thereby forming a coating layer 15 to prevent the patterned layer 13 from distortions while forming the protective layer 11 and bottom layer 14. The coating resin is selected from a group consisted of polyamide, polystyrene and polypropylene.

Referring to FIG. 6, according to a predetermined shape of the cover 10, the base 12 having the patterned layer 13 thereon can further be molded or trimmed to a suitable shape, before forming the protective layer 11 in step 300. The step of molding is carried out by hot press molding.

In step 300, forming the protective layer 11 on the second surface 122 includes following steps of: referring to FIG. 7, providing a mold 20 that includes an upper molding portion 201 and a lower molding portion 202, the lower molding portion 202 has a molding block 2021, the upper molding portion 201 defines a molding cavity 2011 that substantially conforms to the molding block 2021, and further defines a guiding channel 2012 that communicates with the molding cavity 2011 above the molding cavity 2011; setting the semi finished cover on the molding block 2021; fastening the upper molding portion 201 and the lower molding portion 202 together; introducing a first resin 110 from the guiding channel 2012 onto the second surface 122, thereby forming the protective layer 11. The first resin 110 is selected from a group consisting of polycarbonate, acrylonitrile-butadiene-styrene terpolymer, and polymethyl methacrylate.

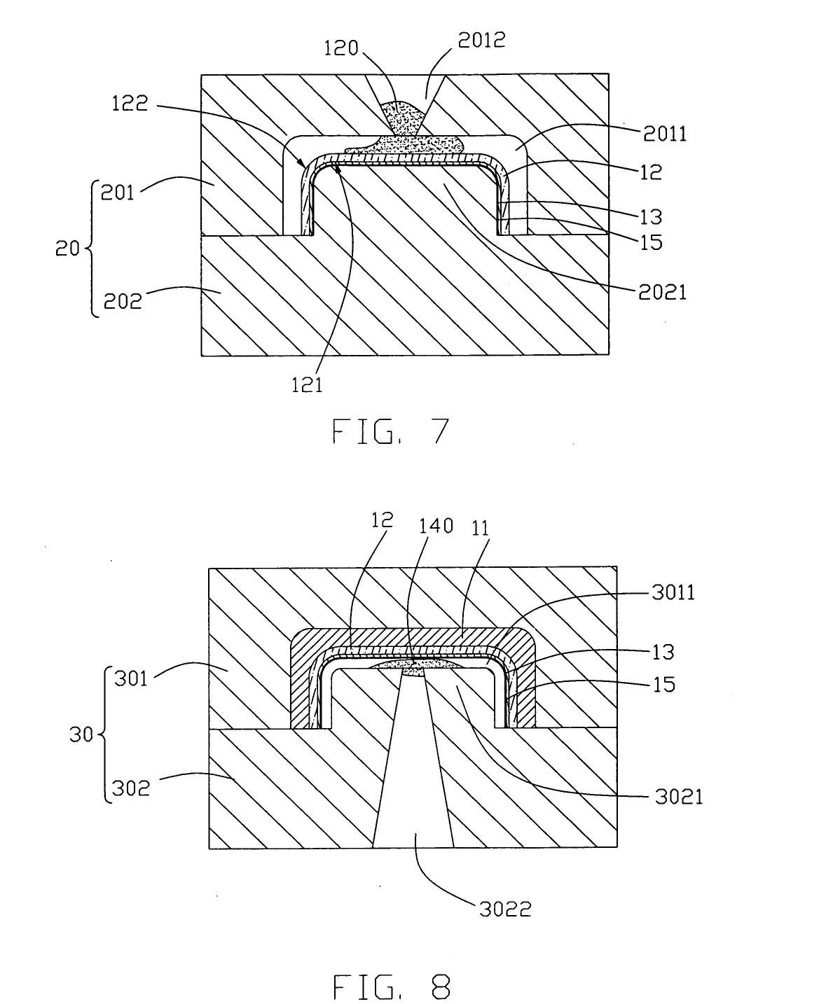

In step 400, forming the bottom layer 14 on the patterned layer 13 includes following steps of: referring to FIG. 8, providing a mold 30 that includes an upper molding portion 301 and a lower molding portion 302, the lower molding portion 302 has a molding block 3021 and further defines a guiding channel 3022 in the molding block 3021, the upper molding portion 301 defines a molding cavity 3011 that substantially conforms to the molding block 3021; setting the semi finished cover that has formed the protective layer 11 on the molding cavity 3011; fastening the upper molding portion 301 and the lower molding portion 302 together; introducing a second resin 140 from the guiding channel 3022 onto the patterned layer 13, thereby forming the bottom layer 14. In addition, if the patterned layer 13 has the coating layer 15 thereon, the second resin 140 is introduced onto the coating layer 15. The second resin 140 is selected from a group consisting of polycarbonate, acrylonitrile-butadiene-styrene terpolymer, polyvinyl chloride, polyethylene, polystyrene, polyamide, and any combination thereof.

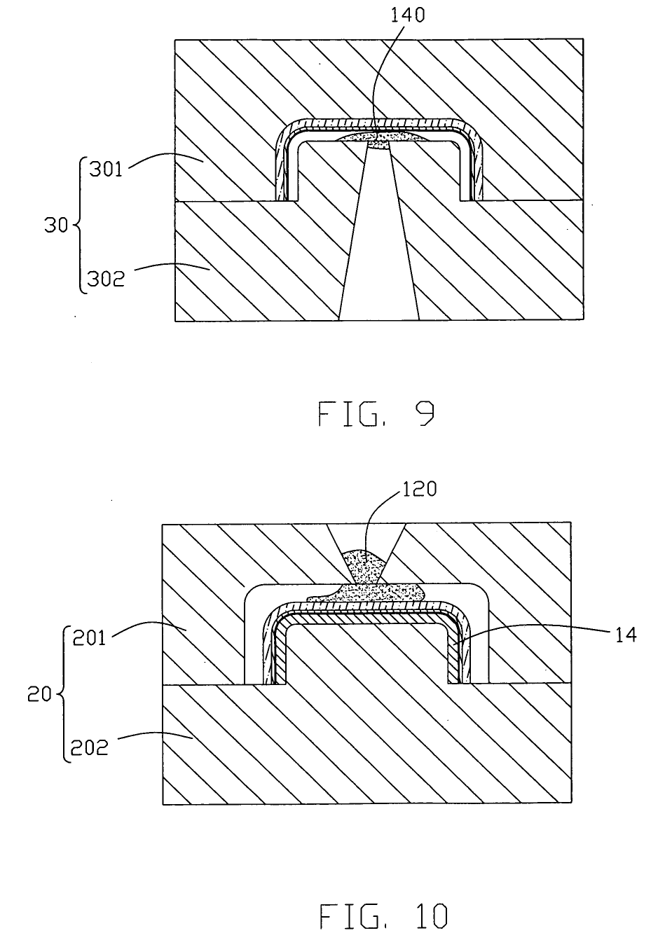

Alternatively, referring to the FIGS. 9 and 10, according to an aspect of the embodiment, the order of step 300 and step 400 can be exchanged. Also, according to another aspect of the embodiment, using a different mold, the step 300 and step 400 can be carried out simultaneously.

While the present invention has been described as having preferred or exemplary embodiments, the embodiments can be further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. A cover comprising:
a base having a first surface, and a second surface on the opposite side of the first surface;
a patterned layer attached on the first surface of the base;
a protective layer integrally formed on the second surface of the base by injection molding; and
a bottom layer integrally formed on the patterned layer by injection molding.

2. The cover as described in claim 1, wherein the base is one of a transparent film and sheet.

3. The cover as described in claim 2, wherein a material of the base is selected from a group consisting of polycarbonate, acrylonitrile-butadiene-styrene terpolymer, polyvinyl chloride, polyamide, and polymethyl methacrylate.

4. The cover as described in claim 1, wherein the patterned layer is selected from a group consisting of printing ink layer, metal plated layer, and a combination thereof.

5. The cover as described in claim 1, wherein the protective layer is one of a semi-transparent and transparent layer.

6. The cover as described in claim 5, wherein a material of the protective layer is selected from a group consisting of polycarbonate, acrylonitrile-butadiene-styrene terpolymer, and polymethyl methacrylate.

7. The cover as described in claim 1, wherein a material of the bottom layer is plastic.

8. The cover as described in claim 7, wherein the plastic is selected from a group consisting of polycarbonate, acrylonitrile-butadiene-styrene terpolymer, polyvinyl chloride, polyethylene, polystyrene, polyamide, and any combination thereof.

9. The cover as described in claim 1, further comprising a coating layer sandwiched between the patterned layer and the bottom layer.

10. The cover as described in claim 9, a material of the coating layer is selected from a group consisted of polyamide, polystyrene and polypropylene.

11. A method for manufacturing a cover, comprising the steps of:
providing a base having a first surface, and a second surface on the opposite side of the first surface;
attaching a patterned layer on the first surface of the base;
forming a protective layer on the second surface of the base by injection molding; and
forming a bottom layer on the patterned layer by injection molding.

12. The method as described in claim 11, wherein the step of forming the patterned layer on the first surface of the base is performed by one of electroplating, evaporation, sputtering, and printing process.

13. The method as described in claim 11, wherein after the step of forming the patterned layer on the first surface of the base, the base with the patterned layer are molded by hot press molding.

14. The method as described in claim 11, wherein after the step of forming the patterned layer on the first surface of the base, the base with the patterned layer are trimmed to a suitable shape.

15. The method as described in claim 11, wherein the step of forming the protective layer is performed by using a mold that comprises an upper molding portion and a lower molding portion; the lower molding portion has a molding block; the upper molding portion defines a molding cavity engaged with the molding block, and defines a guiding channel that communicates with the molding cavity above the molding cavity.

16. The method as described in claim 11, wherein the step of forming the bottom layer is performed by using a mold that comprises an upper molding portion and a lower molding portion; the lower molding portion has a molding block and defines a guiding channel in the molding block; the upper molding portion defines a molding cavity engaged with the molding block.

17. The method as described in claim 11, wherein the order of the step of forming the protective layer and the step of forming the bottom layer is exchanged.

18. The method as described in claim 11, wherein the step of forming the protective layer and the step of forming the bottom layer are carried out simultaneously.

19. The method as described in claim 11, further comprising a step of forming a coating layer on the patterned layer after forming the patterned layer.
